(19) United States
(12) Patent Application Publication
(10) Pub. No.: US 2023/0304563 A1
(43) Pub. Date: Sep. 28, 2023

(54) METHOD FOR ATTACHING AN END TERMINAL AND SPLITTING DEVICE THEREFOR

(71) Applicant: PAUGER KFT., Budapest (HU)

(72) Inventor: Dénes PAULOVITS, Budapest (HU)

(73) Assignee: PAUGER KFT., Budapest (HU)

(21) Appl. No.: 18/020,600

(22) PCT Filed: Aug. 24, 2021
(86) PCT No.: PCT/HU2021/000012

§ 371 Date: Feb. 9, 2023

(30) Foreign Application Priority Data
Aug. 26, 2020 (HU) P2000280

(51) Int. Cl. F16G 11/04; B29C 70/20

(52) U.S. Cl. CPC F16G 11/042; B29C 70/20; B29K 2307/04

(57) ABSTRACT

The invention relates to a method for affixing an end terminal to a solid carbon rod (1). The invention further relates to a splitting device applicable for carrying out the method according to the invention. The method is characterized in that it comprises at least the following steps: a) providing a solid carbon rod (1) cut to an appropriate length, b) splitting the carbon rod (1) into several smaller cable portions (3) along a predetermined split length (L1) in the direction of the longitudinal axis of the carbon rod (1), substantially without damaging the individual carbon fibres, where the cross-sectional size of the smaller cable portions (3) obtained through splitting is smaller than 5 mm², preferably smaller than 2 mm², more preferably smaller than 1 mm². c) spacing apart the split cable portions (3) from each other in the radial direction of the cross section of the carbon rod (1), and forming—and, optionally, temporarily, fixing —a preferably conically shaped end portion (2) from the cable portions (3) thus obtained, d) affixing an end terminal (4, 5, 6) to the branched end portion. The device is characterized in that it comprises a centring clamp unit (9), a movable blade holder (7), and one or more blades (8) retained in the movable blade holder (7), where the movable blade holder (7) is situated opposite the centring clamp unit (9) and is configured such that it is slidable along the longitudinal axis of a carbon rod (1) retained in the centring clamp unit (9), and is rotatable about the axis of the retained carbon rod (1).

### TECHNICAL FIELD

The invention relates to a method for attaching an end terminal to a solid carbon rod with unitary inner structure. The invention further relates to a splitting device applicable for carrying out the method according to the invention.

### BACKGROUND ART

A possible process for affixing conical end terminal s to stranded steel cables, wire ropes, and Bowden cables involves separating the strands of the cable from each other, bending the strands in such a way that their configuration corresponds to the cone angle of the conical end terminal, and then filling up the space between the strands with an adhesive. For example, the socketing solution described and marketed by SocketLock works based on this principle. In itself, this technical solution has the disadvantage that the strands are connected to each other only mechanically, by a form-fitting connection, i.e., for example in the case of steel wires, the strands are wrapped together, so this solution cannot be applied with solid carbon rods.

Another prior art technical solution is described in the document WO2015071858A1 that discloses an end terminal for cables comprising high tensile-strength and high-modulus unidirectional fibres, wherein the fitting comprises two main elements: an external socket and an internal spike. Both main elements are elongated, radially symmetrical members. The socket has a tapered bore defining a tapered inner surface and the spike has a tapered outer surface that are shaped cooperatively such that when they are assembled to one another, the annular space between these surfaces is of substantially unitary cross-sectional area along their respective lengths, so that the yarns are confined along the entire length of the spike and socket.

In the case of the known technical solutions, especially in the field of application of carbon rods, the end terminal of the strands is configured such that multiple parallel strands are applied for providing a stable attachment of an end terminal. With current known solutions, a similar attachment cannot be provided applying a single solid carbon rod.

### DISCLOSURE OF INVENTION

The objective of the invention is to provide a method that can be applied for placing an end terminal on a solid carbon rod and securing it thereon in a simpler, faster, and more practical manner compared to existing methods for affixing end terminals.

A further objective of the invention is to provide a splitting device that can be applied for carrying out the splitting operation required for the method in a simple and speedy manner.

The method and splitting device according to the invention are both based on the recognition that anisotropic materials, for example carbon fibre-reinforced composite materials with epoxy resin matrix can under appropriate circumstances be separated without causing substantial damage to the carbon fibres, and thus can be separated into several segments by mechanical means, preferably by splitting. Such a splitting operation makes use of the low interlayer shear strength characteristic of composite materials, due to which unidirectional fibre-reinforced composite materials can be split easily in the direction of the fibres. In the case of a structure comprising unidirectional fibres, this raises the possibility—unexpected even to a person skilled in the art—that the structure can be split along the fibres up into very small portions applying a knife or blade, substantially without damaging the fibres.

The objective of the invention is fulfilled by providing a method for securing an end terminal to a solid, carbon rod with unitary inner structure, wherein the method comprises at least the following steps:

a) providing a solid carbon rod cut to an appropriate length,

b) splitting the carbon rod into several smaller cable portions along a predetermined split length in the direction of the longitudinal axis of the carbon rod, substantially without damaging the individual carbon fibres, where the cross-sectional size of the smaller cable portions obtained through splitting is smaller than 5 mm², preferably smaller than 2 mm², more preferably smaller than 1 mm²,

c) spacing apart the split cable portions from each other in the radial direction of the cross section of the carbon rod, and forming—and, optionally, temporarily, fixing—a preferably conically shaped end portion from the cable portions thus obtained,

d) affixing an end terminal to the branched end portion.

For the process of separating and spacing apart the smaller cable portions it is not an essential requirement that the distribution of the fibres is completely regular, the intention is only to provide that the space-filling material has appropriately large bonding surface so that it can fulfil its role in the form-fitting connection.

In a preferred realization of the method according to the invention, step d) comprises the following steps:

d1) pulling an end terminal onto the branched end portion such that the branched end portion that preferably has a conical shape forms a substantially matching unit with the internal spatial configuration of the end terminal

d2) filling up the internal volume defined by the end terminal with a liquid-phase matrix material, for example a thermosetting adhesive, preferably a synthetic resin, and subsequently bringing about a form-fitting connection through the solidifying of the matrix material.

In another preferred realization of the method according to the invention, step d) comprises the following steps:

d1) affixing, by adhesive bonding, a spike portion made integral with an end terminal, into the branched end portion between the split cable portions (3), and

d2) bringing about, applying a winding process, a form-fitting connection on the surface of the spike portion around the cable portions of the split carbon rod affixed to the spike portion.

In a further preferred realization of the method according to the invention, splitting is carried out in one or more steps applying one or more blades arranged beside each other.

In a further preferred embodiment of the method according to the invention, following step d) of the method the section of the branched, preferably conical end portion extending over the end terminal affixed thereon is removed.

In a preferred realization of the method according to the invention, the matrix material applied in the process is a thermosetting or thermoplastic matrix material.

In a preferred embodiment of the method according to the invention, the matrix material applied in the process is an epoxy resin.

The invention further relates to a splitting device for carrying out the method according to the invention, the device comprising a centring clamp unit, a movable blade holder, and one or more blades retained in the movable blade holder, where the movable blade holder is situated opposite the centring clamp unit and is configured such that it is slidable along the longitudinal axis of a carbon rod retained in the centring clamp unit, and is rotatable about the axis of the retained carbon rod.

### BRIEF DESCRIPTION OF THE DRAWINGS

The method according to the invention is explained below referring to the accompanying drawings, where

FIG. 1a shows the arrangement of fibres in a solid carbon rod,

FIG. 1b shows the carbon rod shown in FIG. 1a in a state wherein its end portion is split and branched,

FIGS. 2a-2d illustrates a preferred embodiment of the splitting device applied for carrying out the method, showing a preferred way of performing the splitting step according to the invention,

FIG. 3a is the sectional view of a preferred embodiment of the end terminal comprising a conical internal bore,

FIG. 3b illustrates the application of the end terminal illustrated in FIG. 3a placed on a solid carbon rod according to FIGS. 1a and 1b,

FIG. 4 illustrates an end terminal configured as a spike according to another preferred embodiment, showing the end terminal placed into the solid carbon rod of FIGS. 1a and 1b, and

FIG. 5 illustrates a plate-type end terminal according to a further preferred embodiment, showing the end terminal placed into the solid carbon rod of FIGS. 1a and 1b.

### BEST MODE OF CARRYING OUT THE INVENTION

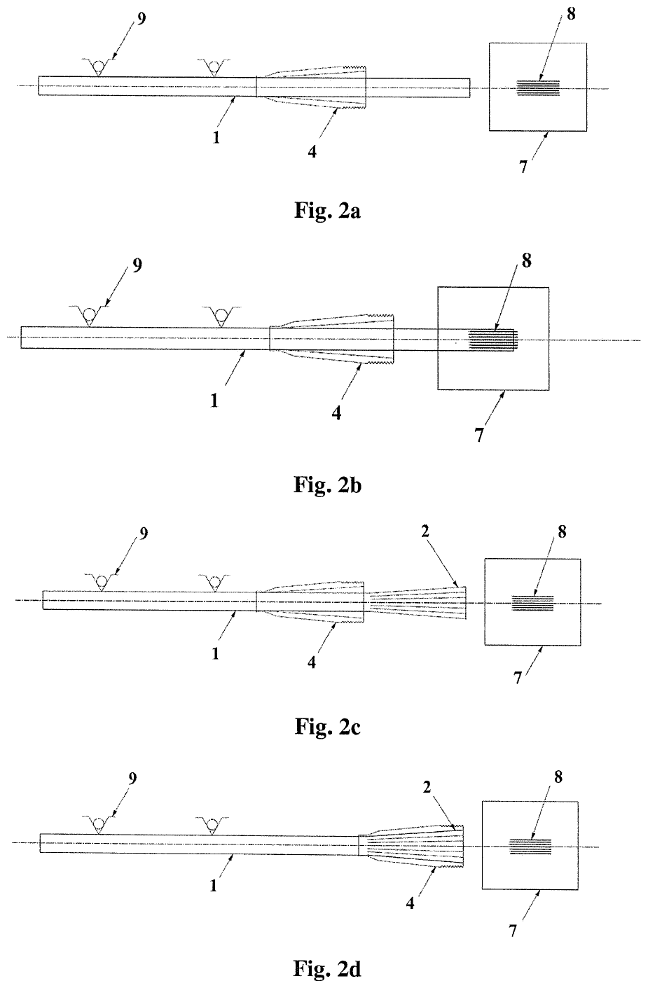

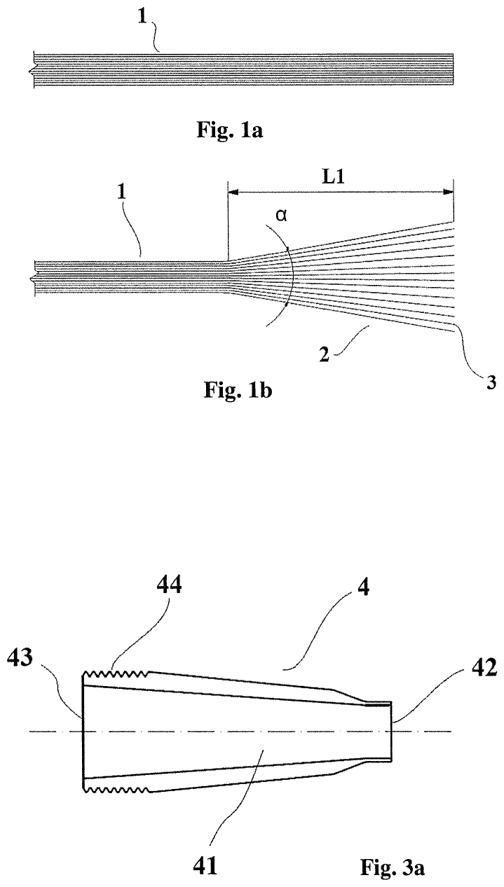

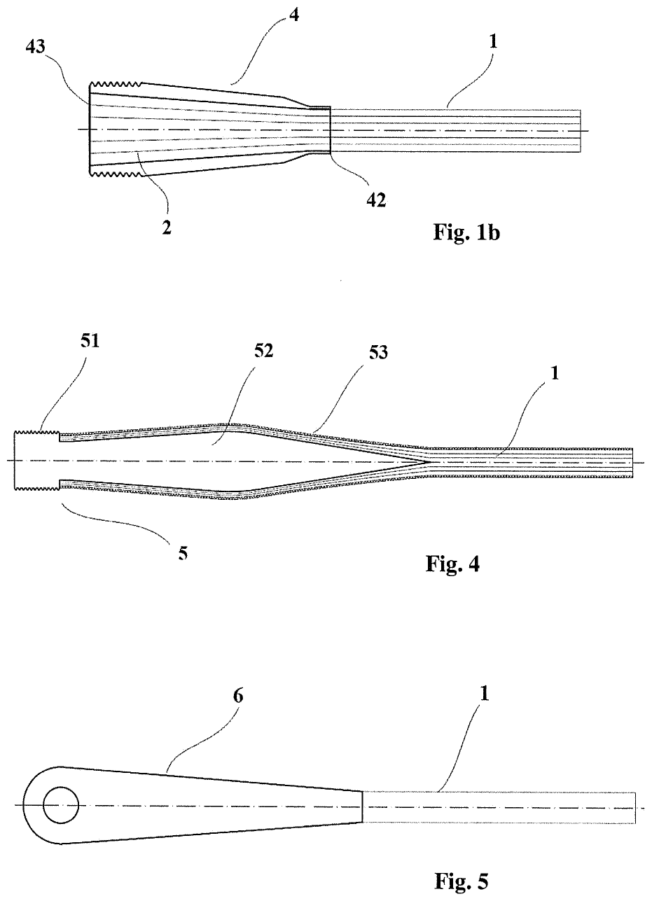

As the first step of the method, a solid carbon rod 1 is provided. The arrangement of the fibres of such a solid carbon rod 1 is illustrated in FIG. 1a. Solid carbon rods 1 are carbon rods fabricated by impregnating unitary directed carbon fibres.

A preferred solid carbon rod 1 is made by impregnating several unitary directed carbon fibres while providing a controlled fibre tension. The impregnated carbon fibres are compressed by a winding process or by another type of compression bonding, applying for example heat-shrink braids that compress the impregnated carbon fibres between which the matrix material is in a cross-linked state after the shrinking process.

The chosen diameter of a solid carbon rod 1 is dependent on the loads the cable must withstand, so it can vary in accordance with the intended application. End terminals of different diameter and geometrical configuration can be affixed to carbon rods 1 of different thickness.

In the next step of the method, the carbon rod 1 is split along its longitudinal direction. Splitting is performed such that the parallel fibres are disjoined but the individual fibres continuity are not interrupted or just a few fibres are interrupted by the splitting. Splitting can be performed in various ways.

FIG. 3a illustrates a preferred configuration of the end terminal. The end terminal 4 comprises an external threaded portion 44 adapted for connecting/retaining the fitting, and an internal hollow portion 41 that is preferably implemented as a conical bore increasing in diameter from the inset end 42 in the direction of the outset end 43. The end terminal 4 is configured such that the diameter of the inset end 42 is substantially the same (having a loose tolerance fit) as the diameter of the solid carbon rod 1, while the internal hollow portion 41 is preferably a conical portion with a cone angle of less than 10°. The exact value of the cone angle is selected to match a preferred matrix material; in the case of an exemplary epoxy resin matrix material the appropriate angle is about 4°.

The attachment of such an end terminal is illustrated in FIG. 3b. The solid carbon rod 1 is pulled through the internal hollow portion 41 of the end terminal 4 from the direction of the inset end 42 in the direction of the outset end 43, followed by carrying out the splitting steps and attaching the fitting in the open state to the free end, thereby forming a branched, preferably conical end portion 2 of the carbon rod 1. Thereafter, the internal hollow portion 41 of the end terminal 4 is pulled on the preferably conical branched end portion 2 such that the temporary glued portion situated at the end of the end portion 2, or the temporary ring is situated outside the internal hollow portion 41 of the end terminal 4, and finally the internal hollow portion of the end terminal is filled up with a matrix material that is hardened applying a known hardening/setting method applicable for the matrix material (for example, applying heat).

For carrying out an exemplary, preferred method a splitting device can be applied (see FIGS. 2a-2d) that comprises a centring clamp unit 9, a movable blade holder 7, and one or more blades 8 retained by the one or more movable blade holders 7. The movable blade holder 7 is situated opposite the centring clamp unit 9, and is configured such that it can slide along the longitudinal axis of a carbon rod 1 retained in the centring clamp unit 9. This is preferably allowed, for example, by applying a system of rails or guides known per se from the technical field of turning machines for supporting the movable blade holder.

Further, the movable tool holder 7 is configured such that it can be rotated about its own axis, and can be stopped either at predetermined angular positions, or in certain embodiments, at a freely selectable angular position. It is thereby provided by the movable tool holder 7 that the splitting planes of the retained one or more blades 8 lie at an angle with respect to a previously applied splitting plane.

The carbon rod 1 is inserted and retained in the centring clamp unit 9. Thereafter, an end terminal 4 comprising a hollow portion is placed on the carbon rod 1 from the direction of the free end of the retained carbon rod 1. The carbon rod 1 is retained in the centring clamp unit 9 such that, by abutting the end terminal 4 comprising a hollow portion against the centring clamp unit 9 the cable portion extending from the end terminal 4 has at least such a length that a given split length of the cable is machinable by the movable blade holder 7. Such a retaining configuration is illustrated in FIG. 2a.

The carbon rod 1 is split along a given split length L1 in its longitudinal direction (see FIG. 2b) by displacing the movable blade holder 7 dynamically or statically (applying a constant push) along the longitudinal axis of the carbon rod 1, thereby providing that the blades 8 can enter, along the given split length, the matrix material of the carbon rod 1 and between the carbon fibres forming the longitudinal strands of the carbon cable 1. After that, the movable blade holder 7 is removed from the carbon cable 1 along the axis of the retained carbon cable 1 (see FIG. 2c).

The maximum displacement of the movable blade holder 7 is set for example by applying a stop piece, but other solutions known per se, for example numeric or computer control can also be suitable for this purpose.

In the course of the method, two steps of the process can be repeated several times by rotating the movable blade holder 7 about its own axis to achieve the desired results. The movable blade holder 7 can thus be rotated about its own axis and can be fixed at selectable angular positions.

In the case of carbon cables 1 having different load bearing capacity, end terminals specially configured in different ways to match the different load values can be applied, i.e., different split patterns correspond to different-diameter carbon cables 1.

After performing the splitting step in the required manner, the cable portions 3 of the carbon cable 1 provided by the splitting step are secured in a space-apart position. The portions can be spaced apart from each other for example by applying a conical spike that is inserted into the movable blade holder 7 substituting the blades, such that the cable portions 3 spaced apart by the spike in a uniform manner are secured with respect to each other applying temporary adhesive bonding.

In the subsequent step of the method (see FIG. 2d) the end terminal 4 is pulled on the end portion 2 formed in this way.

In the course of the method, splitting must be carried out such that the cross-sectional area of the individual split cable portions 3 is small enough to allow that the fibres can be appropriately bent for providing a uniform arrangement thereof in the end terminal 4. The cross-sectional size of the smaller cable portions 3 obtained by splitting is therefore expediently not greater than 5 mm², preferably not greater than 2 mm², more preferably not greater than 1 mm²

As an example, the splitting process of a specific solid carbon cable 1 with a diameter of 7 mm will be described. In this case, a splitting device consisting of five blades spaced apart uniformly along the width (7 mm) of the device can be applied for carrying out the splitting process in four steps. Between the four splitting steps, the splitting device is rotated substantially by 45° or by a multiple of 45° corresponding to the pattern. In the case of the pattern obtained this way, cable portions 3 with different cross-sectional size, but with a cross sectional size that is uniformly smaller than 1 mm², are formed.

It is to be noted that, in the process carried out according to the exemplary method the degree of rotation of the splitting device, the number of splitting steps, and the configuration of the splitting device are not restricted to the parameters set forth in the exemplary embodiment, i.e., this step of the method can also be carried out applying different settings.

In FIG. 3b, the angle of the conical wall of the internal hollow portion 41 is configured to correspond to the matrix material applied for the method, thus ensuring an appropriate bonding. The inside cone angle is preferably between 1-10°; in the case of the epoxy resin applied in a preferred embodiment it is for example preferably 4°.

In the case of an end terminal 4 according to FIGS. 3a and 3b, if the required bonding length is known, then the other parameters of the inside cone of the end terminal can be determined in a manner known to a person skilled in the art based on the diameter of the applied solid carbon cable 1 and the cone angle.

It is noted here that, although FIGS. 3a and 3b illustrate a preferred embodiment of the end terminal 4 wherein the internal hollow portion 41 has a conical configuration, the method can also be applied with end terminals that are configured differently. It is for example conceivable that the internal opening into which the split end portion 2 is inserted has a different geometrical configuration that provides an appropriate form-fitting and/or frictional connection.

After splitting, the individual cable portions 3 are spaced apart from each other in the radial direction of the cross section of the carbon cable 1, thereby providing a branched, preferably conical geometrical configuration at the end of the carbon cable 1.

The conical geometry is preferably formed applying a conical spike that is inserted (driven) between the split cable portions 3 in a centred manner in the axial direction of the carbon cable 1. As the conical spike is inserted in a centred manner, the split-up cable portions 3 are bent outward uniformly along the cone. The uniformly bent cable portions must be bent outward such that they diverge at a given cone angle α inside the cone of the end terminal to be applied. For example, for the end terminal having an inside cone angle of 4° mentioned above, this implies a maximum cone angle of 4°. Because an accurate fit is not required, and because the cable portions 3 are not completely straight when they are bent outward, the cone angle α of the cable portions 3 will typically only approximately be the same as the cone angle of the internal cone.

After forming the outward bend of the cable portions 3, the cable portions 3 are fixed in their specified position, followed by removing the conical spike. A preferred solution for fixing the cable portions is applying adhesive to the ends of the branched, preferably conical end portion 2. After the adhesive has dried, it temporarily keeps the cable portions 3 in the desired position relative to each other.

However, it has to be noted that the cone angle can also be formed by other means, for example by inserting a spacer ring or other spacer member with holes, or by inserting a wedge-like internal cone member between the cable portions 3 (which wedge-like cone member will then stay between the cable portions).

In the next step of the method, the temporarily fixed branched (preferably conical) end portion 2 is arranged in a corresponding internal cavity, preferably a bore, of an end terminal, filling up the remaining free spaces with a matrix material.

The empty spatial regions between the fibre portions arranged inside the internal hollow portion can be filled up for example making use of gravity (by arranging the end terminal vertically) and also by high-pressure injection.

Thereafter, in case the split-up fibre portions extend over the conical portion of the end terminal, the overextending portions are removed. The fibre portions can be removed applying a process known per se, for example cutting.

FIG. 4 illustrates an end terminal 5 configuration applicable with another method. The end terminal 5 illustrated in FIG. 3 comprises a threaded portion 51 and a spike portion 52. In the case of an end terminal shown in FIG. 3, the method according to the invention can be applied such that the end terminal is inserted into the split-up, branched end portion 3 of the split solid carbon cable 1, and then it is secured by applying a matrix material for providing an adhesive bond around the spike portion 52. To provide a secure attachment, an outer jacket 53 is formed by a winding process around the cable portions 3 of the split-up carbon cable 1 applying for example heat-shrink braids that compress the impregnated carbon fibres between which the matrix material is in a cross-linked state after the shrinking process.

FIG. 5 illustrates an end terminal 6 configuration applicable with a further method. In this case, the end terminal 6 is assembled from end terminal plates 6′ by making parallel cuts in the solid carbon cable 1 simultaneously or successively in order to increase the adhesion surface area for the plates, inserting the end terminal plates 6′ into the cuts, and securing them therein by adhesive bonding.

To provide a secure attachment, cable portions 3 of the split-up carbon cable 1 are optionally compressed by a winding process, applying for example heat-shrink braids that compress the impregnated carbon fibres between which the matrix material is in a cross-linked state after the shrinking process.

The material applied for final bonding can for example be the same synthetic resin, preferably epoxy resin that constitutes the matrix material of the carbon cable 1, but other matrix materials with suitable technical parameters can also be applied. The liquid-phase thermosetting adhesive is solidified applying a suitable heat treatment, thereby providing a form-fitting connection and/or an adhesive bonding for the conical end terminal.

A great advantage of the method is that an end terminal can be applied to a solid carbon cable 1 (instead of a cable with multiple parallel strands), so for the same tensile strength the total cross-sectional area is reduced, or a higher tensile strength can be achieved with the same cross-sectional area in the case of tensile-loaded unidirectional fibres.

Another advantage of the method with respect to existing solutions is that solid carbon cables made from carbon fibres of different thickness can be prefabricated such that the end terminals that are required for their application can be attached post-manufacturing. This characteristic of the method provides great manufacturing flexibility and further possibilities for applying carbon fibre technology.

The solid carbon cables applied in this manner have a greater carbon fibre content compared to the fibre-containing cables applied in prior art technical solutions, and thus the technical parameters of the carbon cable provided with the end terminal are improved compared to the cables provided with end terminals according to existing technical solutions.

A further advantage of the method is that it provides a new mode for affixing an end terminal that is speedier than the existing technical solutions, and has more favourable technical parameters from the aspect of the end product.

### LIST OF REFERENCE NUMERALS

1—carbon rod
2—end portion
3—cable portion
4—end terminal
41—internal hollow portion
42—inset end
43—outset end
44—external threaded portion
5—end terminal
51—threaded portion
52—spike portion
53—outer jacket
6—end terminal plate
7—movable blade holder
8—blade
9— centring clamp unit
α—cone angle
L1—split length

1. Method for securing an end terminal to a solid; carbon cable (1) with unitary inner structure comprising:
a) providing a solid rod (1) constituted by unitary directed carbon fibres,
b) splitting a predetermined split length (L1) of the solid rod (1) into several smaller portions (3) along a longitudinal axis of the carbon rod (1), without substantially damaging the carbon fibres, the smaller cable portions (3) obtained through splitting having a cross-sectional size of less than 5 mm²,
c) spacing apart the smaller portions (3) from each other in a radial direction from cross section of the carbon rod (1), and forming a branched end portion (2) from the smaller portions (3) thus obtained, and
d) affixing an end terminal (4, 5, 6) to the branched end portion.

2. The method according to claim 1, characterized in that step d) comprises the following steps:
d1) pulling an end terminal (4) onto the branched end portion (2) such that the branched end portion (2) forms a substantially matching unit with an internal spatial configuration of the end terminal, and
d2) filling up an internal volume defined by the end terminal with a liquid-phase matrix material, and subsequently solidifying the matrix material.

3. The method according to claim 1, characterized in that step d) comprises the following steps:
d1) affixing, by adhesive bonding, a spike portion (52) having an integral end terminal (5), into the branched end portion (2) between the smaller portions (3), and
d2) bringing about, by applying a winding process, a positive connection of the spike portion (52) around the smaller portions (3) of the solid carbon rod (1).

4. The method according to claim 1, wherein the splitting is carried out using spaced blades.

5. The method according to claim 1, wherein following step d) a section of the branched end portion (2) extending over the end terminal affixed thereon is removed.

6. The method according to claim 2, wherein the liquid phase matrix material is a thermoplastic matrix material.

7. The method according to claim 2, wherein the matrix material is an epoxy resin.

8. Splitting device suitable for splitting an end portion of a solid rod constituted by unitary directed carbon fibres comprising a centring clamp unit (9) adapted to hold the solid rod, a movable blade holder (7) with spaced blades (8) retained in the movable blade holder (7), the movable blade holder (7) being situated opposite the centring clamp unit (9), being slidable along the longitudinal axis of a solid rod (1) retained in the centring clamp unit (9) and rotatable about the axis of the retained solid rod (1).

9. The method according to claim 1, wherein the cross-sectioned size of the smaller cable portions is less than 2 mm².

10. The method according to claim 1, wherein the cross-sectioned size of the smaller cable portions is less than 1 mm².

11. The method according to claim 1, wherein the branched end portion is formed into a conical shape.

12. The method according to claim 2, wherein the liquid phase matrix material is a thermosetting adhesive.

13. The method according to claim 2, wherein the liquid phase matrix material is a synthetic resin.
